(19) United States
(12) Patent Application Publication
(10) Pub. No.: US 2009/0051977 A1
(43) Pub. Date: Feb. 26, 2009

(54) Image processing to reduce image printing time

(75) Inventor: Jay T. Moody, Wayland, MA (US)

Correspondence Address: VISTA PRINT USA, INC.;ATTN: PATENT COUNSEL, 95 HAYDEN AVENUE, LEXINGTON, MA, 02421, US

(73) Assignee: VistaPrint Technologies Limited

(21) Appl. No.: 11/894,216

(22) Filed: Aug. 20, 2007

(51) Int. Cl. H04N 1/387

(52) U.S. Cl. 358/450

(57) ABSTRACT

A digital image containing design elements to be printed and a background not to be printed is processed before printing to prepare a cropped version of the image by detecting and removing areas of background from the top, bottom, right, and left sides of the image. The cropped version of the image and associated positioning information are supplied to the printing system for printing. By reducing the size of the image provided to the printing system to eliminate areas that will receive no color ink, the area that must be traversed by the inkjet print heads is reduced, thereby reducing the time required to complete the printing process and allowing a larger number of items to be printed during a given period of time.

### FIELD OF THE INVENTION

The invention relates to the processing of a digital image to be printed and, more particularly, to processing of an image to reduce the image printing time by reducing the dimensions of the image to be printed.

### BACKGROUND OF THE INVENTION

Printing services Web sites allowing a user to access the site from a computer located at the user's home or work and prepare a custom design to be printed on an item of apparel, such as a t-shirt or other item, are well known and widely used by many consumers and businesses. Typically, these printing services sites allow the user to first review uncustomized images of the various products that are available from the provider. When the user selects a specific product to customize, the sites typically provide online tools allowing the user to provide the text that the user desires to appear on the customized product. The user is also typically allowed to either upload a full color image from the user's computer to be incorporated into the product design or select from a number of colorful and attractive designs, images, and other graphic elements that are provided for the user's use by the printing services provider. Images of the user text entries and the user-selected decorative elements are combined with the basic product image to create a composite image indicating the appearance of the printed product. When the design is completed to the user's satisfaction, the user can place an order through the site for production of a desired quantity of the corresponding printed product using a computer-to-textile printing system, such as the 93X Series of CMYK digital printers from Kornit Digital Ltd., or other suitable product printing system.

Systems using ink jet printing technology, such as the Kornit 93X systems described in U.S. patent publication US2005/0179708 entitled “Digital Printing Machine” involve placing the item to be printed on a printing table and holding the item in the proper position by means of a frame having an opening allowing the ink to be applied. The printing operation is performed while relative motion occurs in two axes. The printing table assembly bearing the item moves along a first axis while an assembly containing an array of printing heads, each head having multiple inkjet nozzles, moves in a perpendicular direction.

With inkjet systems of the type described above, the printing of a high resolution image on a single item can require a significant amount of time. The specific time required to print an image is related to the size of the image being printed. For example, the printing of a 12″×12″ image requires the print heads to cover an area of 144 square inches. At typical printing resolution, the process of moving the print heads over an area of this size to print the image will generally require approximately one minute. Smaller images will take relatively less time and larger images relatively more. The number of items that can be produced by a printing system during a given period of time is, of course, directly affected by the time required to position, print, and remove each item. If the time required to print images on at least some items could be reduced, the number of items that could be produced with the system during a period of time would increase accordingly.

There is, therefore, a need for systems and methods that reduce the time to produce individual items thereby enabling the inkjet printing system to increase the number of items that can be processed during a given period of time.

### SUMMARY

The present invention is directed at satisfying the need for automated systems and methods for reducing the time required to print an image if the image contains printable design elements and a background area that is not intended to be printed.

In accordance with one embodiment of the invention, an image having design elements to be printed and a background not to be printed is processed to create a cropped version of the image such that the cropped version excludes at least a portion of the background while retaining the design elements to be printed.

It is an advantage of the invention that the cropped version reduces the dimensions of the image supplied to the printing system such that the time required to print the image is reduced, thereby allowing a greater quantity of printed products to be produced by a printing system during a given period of time.

These and other objects, features, and advantages of the invention will be better understood with reference to the accompanying drawings, description and claims.

### BRIEF DESCRIPTION OF THE DRAWINGS

FIG. 1 shows an illustrative system with which the invention may be employed.

FIGS. 2A-C depict simplified examples of user-customizable designs.

FIGS. 3A-B depict a simplified design customization display.

FIGS. 4A-D depict simplified examples of designs after customization.

FIG. 5 is flow chart of one method embodying the invention.

### DETAILED DESCRIPTION

It will be understood that while the discussion herein describes an embodiment of the invention in the field of preparation of a customized printed t-shirt, the invention is not so limited and is relevant to any application where the time required for a printing system to print an image on an item can be reduced by reducing the physical dimensions of the image area that must be traversed by the print apparatus.

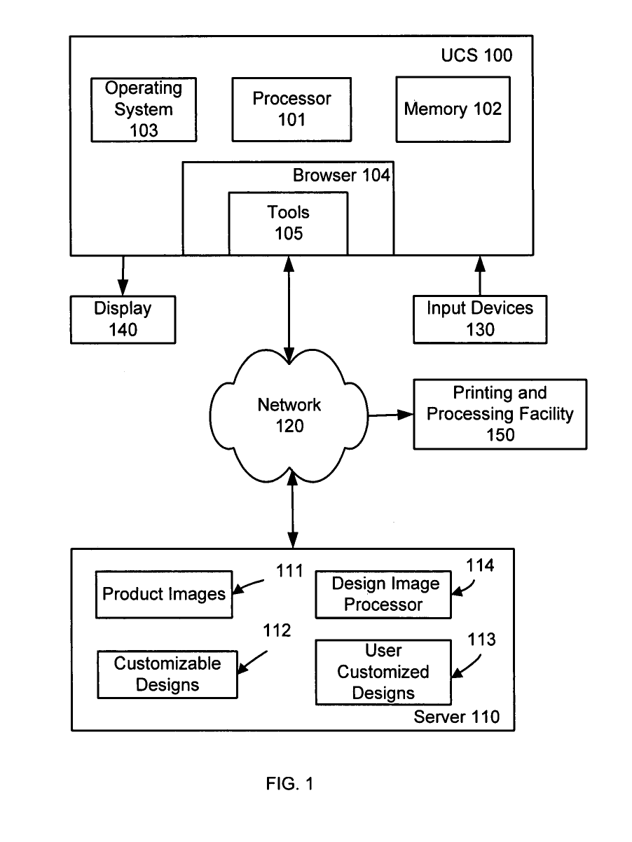

FIG. 1 depicts one illustrative system with which the invention may be employed. User computer system UCS 100 includes processor 101 and memory 102. Memory 102 represents all UCS 100 components and subsystems that provide data storage for UCS 100, such as RAM, ROM, and internal and external hard drives. In addition to providing permanent storage for all programs installed on UCS 100, memory 102 also provides temporary storage required by the operating system and any application program that may be executing. In the embodiment described herein, UCS 100 is a typically equipped personal computer, but UCS 100 could also be any other suitable device for interacting with server 110, such as a portable computer, a tablet computer, or a computer system particularly adapted or provided for electronic product design, such as a product design kiosk, workstation or terminal. The user views images from UCS 100 on display 140, such as a CRT or LCD screen, and provides inputs to UCS 100 via input devices 110, such as a keyboard and a mouse.

When UCS 100 is operating, an instance of the USC 100 operating system, for example a version of the Microsoft Windows operating system, will be running, represented in FIG. 1 by operating system 103. In FIG. 1, UCS 100 is running a Web browser 104, such as, for example, Internet Explorer from Microsoft Corporation. In the depicted embodiment, Tools 105 represents product design and ordering programs and tools downloaded to UCS 100 via network 120 from remote server 110, such as downloadable product design and ordering tools provided by VistaPrint Limited and publicly available at VistaPrint.com. Tools 105 run in browser 104 and exchange information and instructions with server 110 during a design session to support the user's preparation of a customized product. When the customer is satisfied with the design of the product, the design can be uploaded to server 110 for storage and subsequent production of the desired quantity of the physical product on appropriate printing and post-print processing systems at printing and processing facility 150. For the purposed of printing digital images on t-shirts and similar items, facility 150 contains one or more inkjet printing systems, such as the Kornit printing systems discussed above. Facility 150 could be owned and operated by the operator of server 110 or could be owned and operated by another party.

While server 110 is shown in FIG. 1 as a single block, it will be understood that server 110 could be multiple servers configured to communicate and operate cooperatively to support Web site operations. Server 110 will typically be interacting with many user computer systems, such as UCS 100, simultaneously. Server 110 includes the components and subsystems that provide server data storage, such as RAM, ROM, and disk drives or arrays having stored thereon the various computer programs, images, product layouts, designs, colors, fonts, and other information to enable the creation and rendering of electronic product designs.

In the embodiment discussed herein, server 110 includes a number of stored images of various products, such as photographic images of various shirts and other items available for customization and purchase, collectively depicted in FIG. 1 as product images 111. Server 110 also retains a plurality of images and graphic elements, collectively represented as customizable designs 112, that are available for the user to select and add to the user's shirt design for customization purposes. Tools 105 allow the use to enter one or more strings of text for incorporation into the design.

As will be discussed below, the designs that customers have customized and are to be printed are retained in user customized designs 113. As will be discussed in more detail below, design image processor 114 collectively represents the software programs and tools required to analyze a customized design image to identify any portions of the image that can be cropped to reduce the size of the image area that will be printed. Reducing the size of the image reduces the area of the product that must be traversed by the print heads of the inkjet system and, therefore, reduces the total time required to complete the printing of the product. If the printing system employs any pre-printing treatment of the item to be printed, such as applying a wetting solution to the area to be printed to reduce bleeding or diffusion of the ink, the reduction of the image size will also yield a saving in the quantity of wetting solution required.

While shown in FIG. 1 as individual blocks, it will be understood that product images 111, designs 112, user customized designs 113, and design image processor 114 could be stored in a single memory device or distributed across multiple memory devices.

In interacting with server 110 to create a custom product design, the user is typically presented with one or more screen displays (not shown) allowing the user to select a type of product for customization. When the product has been selected, the user may then review thumbnail images of various design images prepared by the site operator and made available for incorporation into the product design and customization by the user. To provide the customer with a wide range of design choices, each design image may comprise a combination of graphics, images, color schemes, and/or other design elements.

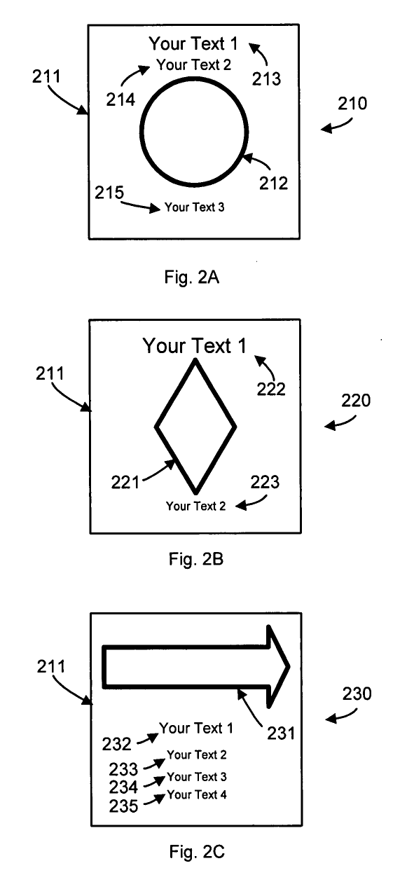

FIGS. 2A to 2C present simplified examples of user-selectable customizable designs 210, 220, and 230. While three designs having basic design elements such as circle 212, diamond 221 and arrow 231 are shown for simplicity of presentation, it will be understood that a printing service provider would typically have a very large number of various designs available to present the user with a wide range of choices of design elements including drawings, graphics, photographs, and the like.

Each design is displayed to the user outlined by an area 211 which indicates to the user the maximum design area that the printing service provider has made available to contain any user-provided content. In the depicted examples, maximum design area 211 is square, but other shapes could be supported, if desired or appropriate for the specific item to be printed. To assist the user in visualizing possible applications for a design, the printing service provider has pre-selected one or more default fonts and has incorporated various text fields 213-215, 222-223, and 232-235 for user-entered text in the designs. While shown in FIGS. 2A-2C as generic entries such as “Your Text 1”, the service provider could, if desired, provide more suggestive text entries about possible text entries, such as “Name of Event”, “Date of Event”, “Company Name”, “Telephone Number”, and the like. The user is not required to enter any text in any of these fields and the user can choose to leave some or all of the text fields empty of any content.

In FIGS. 2A-C, the text entries and the design elements are rendered on the user's display 140 on a white background, commonly referred to as “empty space” or “empty white space”. For printing purposes, this background portion of the design will be transparent and the printing system will not apply any ink in the background area. White is typically used for background display purposes, but other techniques of representing the non-printable background region could be employed, if desired. Printing systems adapted to print on white or light-colored substrates, such as white fabric or paper, employ only colored (i.e., non-white) inks and no ink is applied to any portion of the design that is white. Printing systems adapted to print on dark substrates employ both colored inks and white ink. With these latter systems, no ink is applied to the areas designated as background, but any portions of the design elements specifically designated as having the color white are printed with white ink. For example, if the well-known traffic symbol of a red octagonal stop sign were to be printed on a black shirt, white ink would be applied to the white letters spelling “STOP” in the center of the red octagon (corresponding to white in the design area), but no ink would be applied to the empty white space background outside the red octagon.

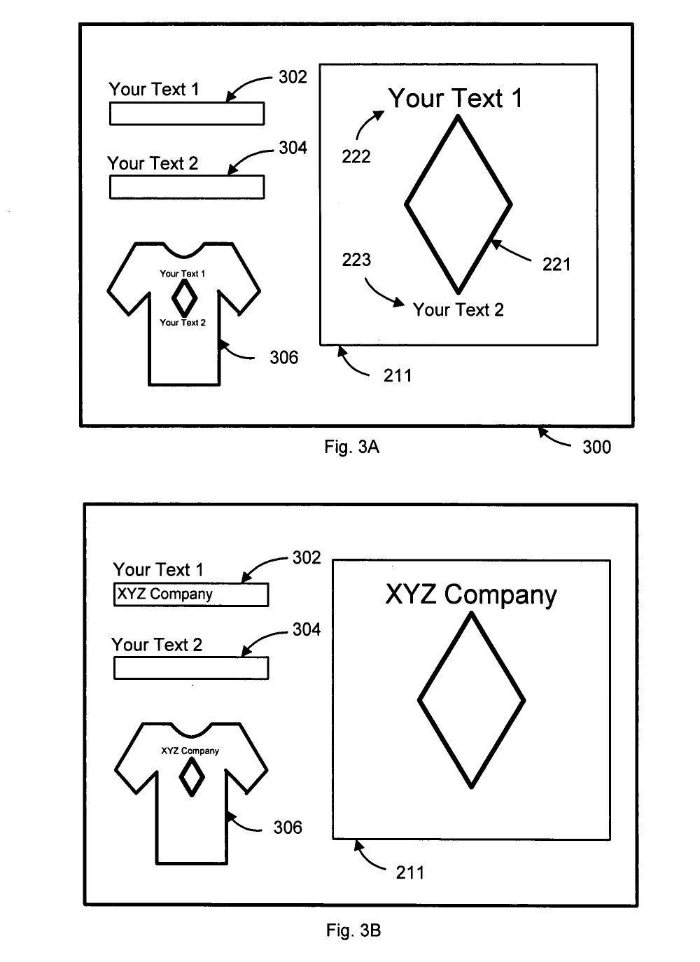

When the user has selected a specific design that the user desires to customize, the user will be presented with a customization page. Simplified initial customization page 300 is depicted in FIG. 3A. In this example, the user has selected a t-shirt as the desired product and has selected the design 220 (FIG. 2B). Initially, the default text entries are displayed in text areas 222 and 223. Thumbnail image 306, showing an image of the t-shirt combined with the current design from printable area 211, provides the user with a visual indication of the appearance of the product. Text entry fields 302 and 304 are provided to allow the user to replace the default text with whatever characters the user desires to appear on the shirt in the areas 222 and 223. The characters entered by the user could include letters, numbers, punctuation marks or other symbols as supported by the site operator. All characters of all types entered by the user are collectively referred to herein as “text”.

In the embodiment discussed herein, images corresponding to the user's text are created at server 110, returned to UCS 100 and rendered by tools 105 at the appropriate locations 222 and 223 relative to design element 221. It will be understood that the printing service provide could, if desired, provide tools to allow the user to further customize the product design, for example select a different font, vary the font size and/or font color, upload a user image, add another text box, and so forth. A typical customization page would also display various additional notices, instructions, controls, navigation tools, and other elements, not shown.

FIG. 3B illustrates the appearance of customization page 300 after the user has replaced the initial default text in field 222 with user-provided text entry “XYZ Company” and has deleted all text from field 223. A revised product image 306 reflecting the current text entries has been generated and displayed. The user can continue to add, delete or modify the text in the custom design 211 until the user is satisfied, at which time the user can proceed to other screens, not shown, to place an order for production and delivery of the desired quantity of the t-shirt printed with the customized design. As discussed below, the content of design area 211 is processed by server 110 prior to printing at processing facility 150

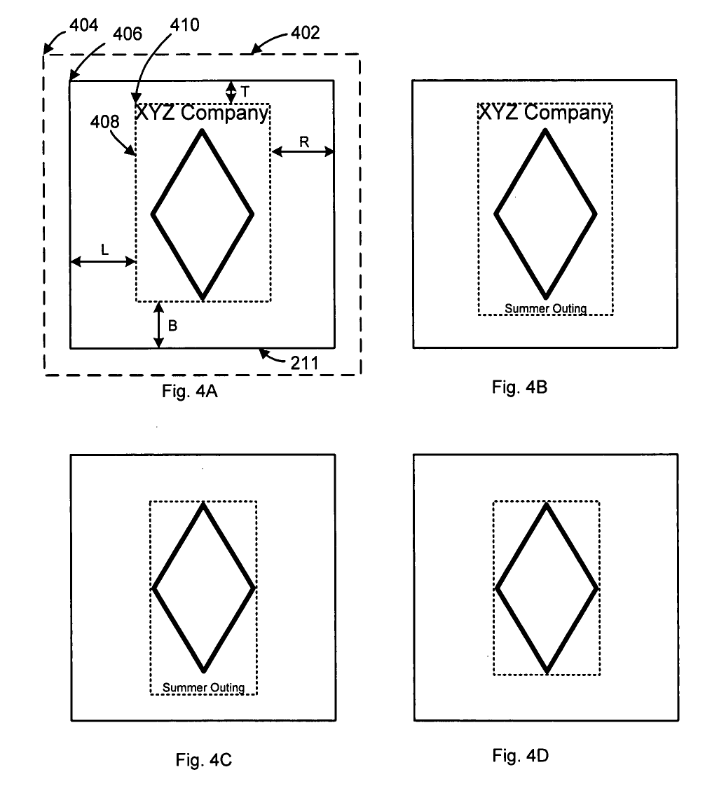

While user-provided content may occasionally fill printable area 211, often this is not the case. Referring to FIG. 4A, an application and benefit of the invention in the situation where all of area 211 is not filled will be discussed. Area 402 schematically represents the maximum physical area that could potentially be printed by the printing system. Upper left corner 404 of area 402, therefore, can be conceptually considered to represent x and y coordinates (0, 0) from which image printing locations within area 402 can be identified. Area 211 is the area that corresponds to the portion of area 402 that would be traversed by the print heads of the printing system to print an image containing all of the image content of area 211.

The physical dimensions of the printed image are controlled by server 110 such that the image size varies according to the size of the associated product. For example, in the disclosed embodiment, if the customer were to order a design to be printed across the chest area of a “small” size t-shirt, the design might be printed at 10″×10″. If the order were for a “large” size t-shirt, the design would be sized to print at 12″×12″, and so forth. The appropriately sized image is provided to the printing system along with the appropriate x and y coordinates specifying the location of the upper left corner of the image as required by the printing system to identify the location within area 402 at which the image will be printed.

The print heads of the printing system will traverse the portion of area 402 corresponding to the size of the received image while activating the appropriate color inkjets at the appropriate locations to cause the image to be printed on the item. As discussed above, no ink will be applied in any area of the design image corresponding to the background. As can be appreciated by studying the example of the design shown in FIG. 3B, in some cases a significant portion of the movement of the print heads over the entire image area 211 would be unnecessary and would lead to a waste of production time. A significant savings in printing time can be obtained by analyzing and modifying the image prior to printing to identify the portion of area 211 actually requiring the application of ink and send only the image of that portion to the printing system.

Referring again to FIG. 4A, the example design from FIG. 3B will be discussed in greater detail. Because only design elements will have any ink applied, only design element areas need to be traversed by the print heads of the printing system. Any time spent by the print heads moving over the background edges of the image is wasted. In the specific example depicted in FIG. 4A, the actual area to be printed within area 211 is contained within actual print area 408. Actual print area 408 is bounded on the top by the top pixel in the text entry “XYZ Company”, on the left by the leftmost pixel in that text entry, on the right by the rightmost pixel in that text entry, and on the bottom by the lowest pixel in the diamond design element. Because all image pixels outside of area 408 are part of the unprinted background, and no ink will be applied, there is no need to require the print heads to move over that region of the image. The content of design area 211 can, therefore, be cropped to remove an amount equal to L from the left edge, R from the right edge, T from the top edge, and B from the bottom edge. All that needs to be sent to the printing system for printing is the portion of area 211 contained within actual print area 408 and the appropriate x and y offset of corner 410 of actual print area 408 to instruct the printing system where within area 402 the image is positioned.

The actual size and position of actual print area 408 will, of course, vary for each custom design based on the size and location of the text entries made by the user. FIGS. 4B-D illustrate a few of the many other possibilities based on the presence or absence of user text in the design.

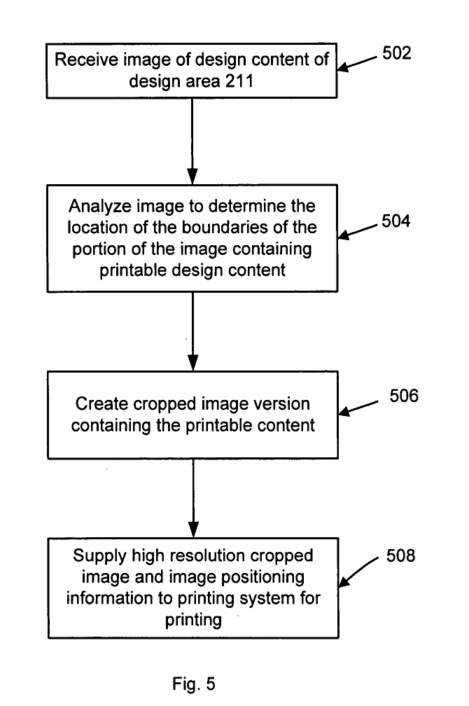

Now, referring to FIG. 5, one method for employing the invention with a printing system employing only color (i.e., non-white) inks for printing on a light substrate will be discussed. At step 502, the user's customized image content of design area 211 is received. At step 504, the software tools of design image processor 114 are used to determine the location within the received image of actual print area 408. While the image will be printed at a resolution of 300 dots per inch or higher, identifying the location of area 408 to this precision is not essential. For example, a commercially available image processing program, such as Adobe Acrobat, could be employed to convert the received area 211 image to a low resolution grayscale bitmap image. Any pixel in the bitmap image having only “white” content will have a value of zero. Therefore, to identify the leftmost edge of actual print area 408, the columns of pixels in the bitmap image could be scanned from left to right searching for the leftmost column containing a grayscale pixel having a non-zero value. To identify the rightmost edge of area 408, the columns could be scanned from right to left to identify the rightmost column containing a non-zero pixel. Similarly, pixel rows would be scanned from top to bottom to identify the first row from the top having a non-zero pixel and scanned from bottom to top to identify the first row from the bottom having a non-zero pixel. Based on the number of pixel columns and pixel rows identified by these four scanning operations, the amount of the received image that can be cropped without removing any printable content can be readily determined. Similarly, the offset coordinates for the cropped image within the printing system's maximum printable area 402 can be calculated and stored for supplying to the printing system.

At step 506, the excess white areas in the received image can be cropped and a high resolution cropped image, such as a PDF, of the determined actual print area 408 can be prepared for printing. It will be appreciated that the analysis of the area 211 image and preparation of the cropped image could be performed by the printing service provider at whatever time is considered most efficient and appropriate between the completion of the customized design by the user and the initiation of the printing process At step 508, the cropped image and the offset positioning information to identify where with area 402 the cropped image should be printed are supplied to the inkjet printing system for printing onto the t-shirt or other selected product.

The above described method can be readily adapted for systems using white inks for printing on dark substrates. For example, design element areas that are to receive white ink could, for the purposes of the image analysis and creation of the cropped version, be assigned a specific color value such that only the background pixels would have a zero value when the design image is converted to a grayscale bitmap.

While an exemplary embodiment of the invention has been discussed, the described embodiment is to be considered as illustrative rather than restrictive. For example, in the embodiment discussed above, the image processing and creation of a cropped version is performed before the cropped version is supplied to the printing system. Alternatively, the image processing and cropping could be implemented in the printing system itself using the printing system's internal processing capability. In this alternate embodiment, the entire design area 211 content could be provided to the printing system and the printing system would handle the image analysis and cropped version creation internally. The scope of the invention is as indicated in the following claims and all equivalent methods and systems.

1. A computer-implemented method for preparing a cropped version of a digital image for printing on a product by an inkjet printing system, the image containing one or more design elements to be printed and a background not to be printed, the method comprising:
processing the image to create a cropped version of the image such that the cropped version excludes at least a portion of the background while retaining the design elements, and
determining image positioning information for use by the printing system in printing the cropped image version on the product.

2. The method of claim 1 wherein the digital image is comprised of a plurality of columns and rows of image pixels and wherein processing the image includes scanning the columns of image pixels from left to right to identify the column having the leftmost design element pixel, scanning the columns of image pixels from right to left to identify the column having the rightmost design element pixel, scanning the rows of image pixels from top to bottom to identify the first row from the top having a design element pixel, and scanning the rows of image pixels from bottom to top to identify the first row from the bottom having a design element pixel.

3. The method of claim wherein the image is converted to a grayscale image prior to scanning the columns and rows of image pixels.

4. The method of claim 1 wherein the digital image has associated positioning information image and wherein the positioning information for the cropped version is determined based on the location of the cropped version within the digital image.

5. The method of claim 1 further comprising
providing the cropped version and the image positioning information to the printing system, and
printing the cropped version on the product.

6. One or more computer readable storage media having stored thereon computer executable instructions which when executed by a computer, perform the method of claim 1.

7. A product printed in accordance with the method of claim 5.

8. A system for preparing a cropped version of a digital image for printing on a product by an inkjet printing system, the image containing one or more design elements to be printed and a background not to be printed, comprising:
means for processing the image to create a cropped version of the image such that the cropped version excludes at least a portion of the background while retaining the design elements, and
means for determining image positioning information for use by the printing system in printing the cropped image version on the product.

9. The system of claim 8, further comprising:
means for sending the cropped version of the image and the image positioning information to the printing system.

10. The system of claim 8, further comprising: the printing system.

11. A computer-implemented method for preparing a digital image having a pre-defined print area for printing on a product by a printing system, the image containing one or more design elements to be printed and a background not to be printed, the method comprising:
analyzing the image to determine the location of boundaries of an actual print area within the pre-defined print area, the actual print area including the design elements of the image and excluding at least a portion of the background;
creating a cropped version of the image containing only the determined actual print area; and
based on the location of the boundaries of the actual print area, determining image positioning information indicating a position of the actual print area relative the pre-defined print area for use by the printing system in printing the cropped image version on the product in a location on the product such that the cropped version of the image appears where it would have on the product had the uncropped image been printed on the product.

12. One or more computer readable storage media having stored thereon computer executable instructions which, when executed by a computer, perform the method of claim 11.
